(19) United States
(12) Patent Application Publication
(10) Pub. No.: US 2024/0372282 A1
(43) Pub. Date: Nov. 7, 2024

(54) DUST TOLERANT CONNECTORS

(71) Applicant: Amphenol Corporation, Wallingford, CT (US)

(72) Inventor: Ritchie Allen Selfridge, Dubois, PA (US)

(73) Assignee: Amphenol Corporation, Wallingford, CT (US)

(21) Appl. No.: 18/636,002

(22) Filed: Apr. 15, 2024

Related U.S. Application Data
(60) Provisional application No. 63/500,411, filed on May 5, 2023.

(51) Int. Cl. H01R 13/04; H01R 13/28; H01R 13/52; H01R 13/642

(52) U.S. Cl. CPC H01R 13/04; H01R 13/28; H01R 13/52; H01R 13/642

(57) ABSTRACT

The techniques described herein relate to dust tolerant connectors. An example electrical connector includes at least one contact having a plurality of protrusions, individual protrusions of the plurality of protrusions having a trunk member, and a head portion extending from the trunk member, wherein a thickness of the trunk member is less than a thickness of the head portion.

### RELATED APPLICATION

This patent claims priority under 35 U.S.C. § 119 (e) to U.S. Provisional Application No. 63/500,411, filed on May 5, 2023, which is hereby incorporated by reference herein in its entirety.

### FIELD

The technology described herein relates generally to electrical interconnection systems and, more particularly, to dust tolerant connectors.

### BACKGROUND

Electrical connectors (connectors) are used in many applications. Some connectors enable making an electrical and physical connection between conductors (e.g., wires, cables, etc.). The electrical connection allows an electrical signal and/or power to flow between the conductors. The physical connection provided by a connector may hold the connectors in place and may allow disconnecting and re-connecting (e.g., mating) the connectors together.

### SUMMARY

In accordance with the disclosed subject matter, dust tolerant connectors are provided.

Some embodiments relate to an electrical connector comprising at least one contact having a plurality of protrusions, individual protrusions of the plurality of protrusions having: a trunk member, and a head portion extending from the trunk member, wherein a thickness of the trunk member is less than a thickness of the head portion.

Some embodiments relate to a pair of mating electrical connectors, comprising a first connector having a first at least one contact having a first plurality of protrusions, individual first protrusions of the first plurality of protrusions having a first trunk member, and a first head portion, wherein a thickness of the first trunk member is less than a thickness of the first head portion. The pair of mating electrical connectors further comprise a second connector having a second at least one contact having a second plurality of protrusions, individual second protrusions of the second plurality of protrusions having a second trunk member, and a second head portion, wherein a thickness of the second trunk member is less than a thickness of the second head portion.

Some embodiments relate to another electrical connector comprising a base, and at least one contact coupled to the base, the at least one contact having a plurality of protrusions, individual protrusions of the plurality of protrusions having a trunk member, and a head portion extending from the trunk member, wherein a thickness of the trunk member is less than a thickness of the head portion.

The foregoing summary is not intended to be limiting. Moreover, various aspects of the present disclosure may be implemented alone or in combination with other aspects.

### BRIEF DESCRIPTION OF FIGURES

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1A shows an example pair of mating contacts, according to some embodiments.

FIG. 1B shows another example pair of mating contacts, according to some embodiments.

FIG. 2A shows the pair of mating contacts of FIG. 1A mated together with their respective axes aligned, according to some embodiments.

FIG. 2B shows the pair of mating contacts of FIG. 1A mated together with their respective axes misaligned, according to some embodiments.

FIG. 3 shows a close-up photograph of one of the pair of mating contacts of FIG. 1A, according to some embodiments.

FIG. 4 shows an example of mating connectors including the pair of mating contacts of FIG. 1A, according to some embodiments.

FIG. 5 shows the mating of the connectors of FIG. 4, according to some embodiments.

FIG. 6 shows a photograph of a large scale mockup version of the mating connectors of FIG. 4, according to some embodiments.

FIG. 7 shows example alignment structures including the mating connectors of FIG. 4, according to some embodiments.

FIG. 8 shows example mating ring-shaped interfaces including the pair of mating contacts of FIG. 1A, according to some embodiments.

FIG. 9 shows an enlarged view of the pair of mating contacts of the ring-shaped interfaces fully engaged with each other, according to some embodiments.

FIGS. 10A and 10B show graphs representing example contact resistance data associated with another example implementation of a pair of mating contacts over a plurality of durability cycles, according to some embodiments.

FIGS. 11A and 11B show photographs of the another example implementation of the pair of mating contacts under test conditions corresponding to the graphs of FIGS. 10A and 10B, according to some embodiments.

FIG. 12 shows a graph representing example contact resistance data for an example implementation of the pair of mating contacts of FIG. 1A during engagement and separation in a durability cycle, according to some embodiments.

FIG. 13 shows a graph representing example contact resistance data for an example implementation of the pair of mating contacts of FIG. 1A during engagement and separation in a durability cycle after being coated with a lunar regolith simulant, according to some embodiments.

FIG. 14 shows a graph representing example contact resistance data for an example implementation of the pair of mating contacts of FIG. 1A during engagement and separation in a durability cycle after a first plurality of coatings of a lunar regolith simulant have been carried out, according to some embodiments.

FIG. 15 shows a graph representing example contact resistance data for an example implementation of the pair of mating contacts of FIG. 1A during engagement and separation in a durability cycle after a second plurality of coatings of a lunar regolith simulant have been carried out, according to some embodiments.

FIG. 16 shows a graph representing example maximum changes in contact resistance data for an example implementation of the pair of mating contacts of FIG. 1A during engagement and separation for a plurality of durability cycles, according to some embodiments.

### DETAILED DESCRIPTION

The present application generally provides techniques for mating electrical contacts and/or, more generally, electrical connectors, in various environments such as dust environments. It has been recognized that dust and/or other debris (e.g., particulate debris) can pose a significant challenge for the reliability of connectors. For example, lunar dust is ubiquitous on the surface of the moon and adheres to many surfaces, including those of connectors. Dust adhering to existing connectors has been shown to reduce connector reliability and hasten connector failure. For example, connectors that include a brush contact may have their bristles coated with dust, which may cause the bristles to splay, reducing reliability and/or accelerating connector failure. In another example, brush contacts with their bristles coated with dust may have increased contact resistance when mated. In such an example, the increased contact resistance may cause significant voltage drops and heating in circuits with high current, which may lead to reduced reliability and/or accelerated connector failure. In electrical circuits used for communication and/or measurement, such increased contact resistance may cause communication degradation and/or significant measurement errors.

The present disclosure describes contacts, connectors, and connector assemblies that can have increased resistance to environments having a high content of particulate matter, such as dust, for example. Example environments include the lunar surface and terrestrial environments having a high content of dust or other particulate matter.

In some embodiments, the contacts may have a plurality of protrusions each having a trunk member and a head portion extending from the trunk member such that a thickness of the trunk member is less than a thickness of the head portion. Beneficially, by configuring the trunk member to be thinner than the head portion, the contact may allow particulate matter to fall out from the contact and thereby overcome the challenges of prior brush contacts. In some embodiments, at least one pair of adjacent head portions of the plurality of protrusions is spaced apart by less than a width of either of the pair of adjacent head portions. Beneficially, by configuring the spacing between at least one pair of adjacent head portions to be less than a width of either of the pair of adjacent head portions, the contact may further be enabled to allow particulate matter to fall out. By allowing particulate matter to fall out, the contacts described herein may shed particulate matter that falls on them and avoid issues with particulate matter buildup (e.g., increased contact resistance, significant voltage drops, heating).

In some embodiments, the contacts may have either a “dart” or “target” configuration to enable increased tolerance of misalignment of the primary central contact axes. For example, a first contact with a first primary central contact axis may have a “dart” configuration by having fewer protrusions than a mating contact. The mating contact may be a second contact with a second primary central contact axis and having a “target” configuration by having more protrusions than the “dart” such that the “target” may receive the “dart”. In such an example, the first and second contacts may be mated even if the first and second primary central contact axes are misaligned because the greater number of protrusions of the “target” provides a greater mating area for the “dart”. Beneficially, in some such embodiments, the contacts provide an electrical interconnect that is tolerant of misalignments created by a primary mechanical interconnect that determines both mechanical position and carries the mechanical loads of the contacts.

In some embodiments, each contact may have the same number of protrusions. For example, the contacts may both have the “target” configuration. Such embodiments have several advantages. First, the mated contact resistance is lower when the number of protrusions for each contact is the same. Second, a larger misalignment between the primary central contact axes of the contacts is permitted while preserving stable contact resistance. Third, manufacturing complexity is reduced by producing contacts having the same configuration. Fourth, field interoperability is improved because one type of spare part is needed for field repairs instead of requiring two types of spare parts (e.g., the “dart” and the “target”). Beneficially, electrical interconnect systems with “dart” and “target” contacts or “target” and “target” contacts as described herein have increased resistance to environments having a high content of particulate matter, such as dust, with respect to conventional electrical interconnect systems.

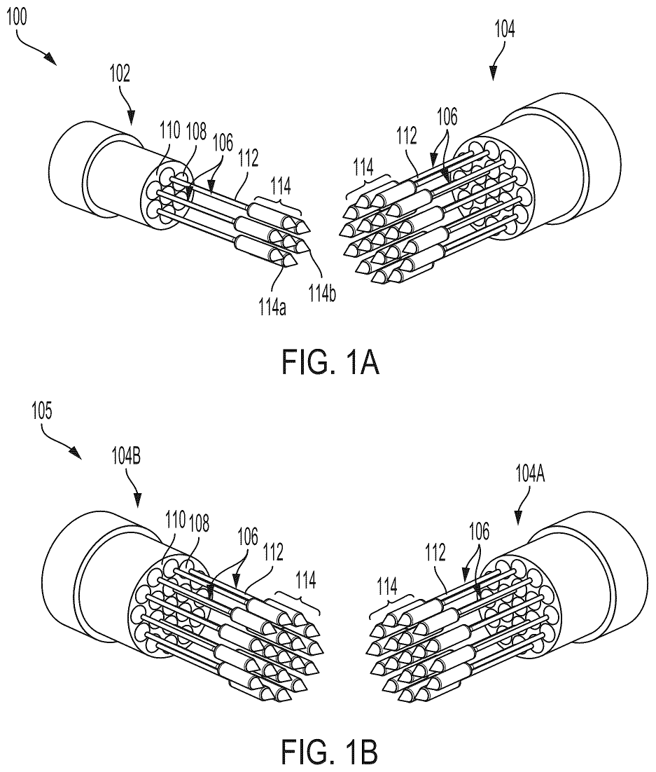

Turning to the figures, the illustrated example of FIG. 1A shows an electrical interconnect system 100 including an example pair of mating contacts 102, 104. In the shown example, a first contact 102 is configured to be mated to a second contact 104. For example, the first contact 102 can be mated to the second contact 104 such that a portion of the first contact 102 is inserted into a portion of the second contact 104.

Each of the contacts 102, 104 includes an array of protrusions 106 extending away from a protrusion base 108. The protrusion base 108 is coupled to a contact base 110. In some embodiments, the protrusion base 108 may be integral with the contact base 110. In some embodiments, the protrusion base 108 may be attached to the contact base 110 through crimping, soldering, or by being snap-fitted into place.

Each protrusion 106 may have and/or include a relatively thin “trunk” member 112 and a thicker “head” portion 114 (not all labeled to avoid obscuring the figure). In some embodiments, the head portion 114 may be at least twice as thick as the trunk member 112. For example, the head portion 114 may be thicker than the trunk member 112 by a factor of 2, 2.1, 2.2, etc., a factor of 3, 3.1, 3.2, etc., and so on. Alternatively, the head portion 114 may be thicker than the trunk member 106 by a factor greater than unity but less than two (e.g., a factor of 1.1, 1.2, 1.3, etc.). As shown, a direction of the thickness of the trunk member 112 and the head portion 114 is perpendicular to an extension direction, and the extension direction is a longest dimension of the individual protrusions 106. As shown, the cross-sectional shape of the thickness is circular. Alternatively, the thickness of the trunk member 112 and/or the head portion 114 may have a different shape, such as square or another polygonal shape.

The engagement/mating end of the head portion 114 may be tapered and/or pointed to facilitate engagement with the protrusions 106 of the opposing contact. For example, the head portion 114 may have a first end and a second end, opposite the first end. The first end may be the engagement/mating end and may be tapered to a point. The second end may also be tapered such that it tapers to a thickness of the trunk member 106.

When engaged, individual ones of the protrusions 106 of the first contact 102 and the second contact 104 extend into one another. When the head portions 114 of the respective contacts 102 and 104 extend past one another, the contacts 102 and 104 may be considered to be fully engaged or mated. For example, the protrusions 106 of the contacts 102, 104 may move against each other for engagement or mating such that a mechanical and/or electrical connection is established. Adjacent head portions 114 may be relatively close together to facilitate mating of connectors. For example, a first head portion 114a and a second head portion 114b are shown as adjacent head portions and may be spaced apart a distance less than a width of either of the adjacent head portions 114a, 114b, in some cases.

In the shown example, the second contact 104 has a greater number (e.g., quantity) of protrusions 106 than a number of protrusions 106 of the first contact 102, and the second contact 104 may be considered a “target” contact. In the shown example, the first contact 102 may have a fewer number of protrusions 106 than the number of protrusions of the second contact 104, and the first contact 102 may be considered a “dart” contact that is configured to extend into the target contact. In other examples, the contacts 102, 104 may have the same number of protrusions 106. The contacts 102, 104 may be the same in some examples or different in other respects (e.g., array area, materials, dimensions, etc.) in other examples.

In the illustrated example, the first contact 102 has seven protrusions 106 and the second contact 104 has 19 protrusions. However, in general, the contacts described herein are not limited to the number of protrusions, which may be a greater or smaller number than those shown. In some cases, the number of protrusions for a contact may be greater than two or three or greater than four or five, for example, to provide a sufficient number of protrusions for mating to the opposing contact.

In the illustrated example, the first and second contacts 102, 104 have a different number of protrusions. Alternatively, the first and second contacts 102, 104 may have the same number of protrusions as shown in FIG. 1B. FIG. 1B shows two “target” contacts identified by reference numerals 104A, 104B and each includes 19 of the protrusions 106. The contacts 104A, 104B shown each correspond to the contact 104 shown in FIG. 1A. Alternatively, the contacts 104A, 104B may have a different number of protrusions 106 such that each may have 10 or more protrusions (e.g., 10 protrusions, 15 protrusions, 20 protrusions, etc.). A “target-to-target” contact electrical interconnect 105 shown in FIG. 1B has several benefits. First, the mated contact resistance is lower when the number of protrusions for each contact is the same. Second, a larger misalignment between the primary central contact axes of the contacts is permitted while preserving stable contact resistance. Third, manufacturing complexity is reduced by producing contacts having the same configuration. Fourth, field interoperability is improved because one type of spare part is needed for field repairs instead of requiring two types of spare parts (e.g., the “dart” and the “target”).

Turning back to FIG. 1A, the protrusions 106 may be formed of any suitable materials. The protrusions 106, trunk member 112, and/or head portion 114 may be formed of an electrical conductor, such as metal. For example, the trunk members 112 may be wires. Example diameters of the wires include 0.005 inches, 0.007 inches, and 0.010 inches. However, the connectors described herein are not limited to particular materials, types of conductors, or diameters of conductors. When formed of metal, any suitable type of metal may be used to form the protrusions 106. Examples of suitable metals include beryllium, copper, nickel, and gold. For example, individual one(s) of the protrusions 106 may be constructed of a beryllium-copper (BeCu) base material with a gold over nickel finish.

In some embodiments, the contacts 102, 104 may be mated together to allow an electrical signal and/or power to flow between conductors of the contacts 102, 104. For example, the contacts 102, 104 may be configured to transfer communication data in accordance with a communication protocol. Examples of communication protocols include 10Base-T, 100Base-T Ethernet, 100Base-TX Ethernet, 100Base-T4 Ethernet, and 1000Base-T Ethernet, Universal Serial Bus (USB), and Serial Peripheral Interface (SPI). Additionally or alternatively, the contacts 102, 104 may be configured to transfer power. Examples of peak power the contacts 102, 104 may be configured to transfer include 500 watts (W), 750 W, 1000 W. Examples of average power the contacts 102, 104 may be configured to transfer include 150 W, 200 W, and 250 W. The contacts 102, 104 may be configured to transfer power at nominal voltages. Examples of nominal voltages include 28 volts (V) direct current (DC) and 120 V DC. The protrusions 106 may be configured to transfer electrical current at nominal electrical currents. Examples of nominal electrical currents include 1 ampere (A), 2 A, 3 A, 4 A, 5 A, etc. For example, one or more of the protrusions 106 of each contact 102, 104 may be configured to transfer 5 A nominal. The above-provided values are merely examples and the contacts 102, 104 are not so limited.

The connectors and contacts described herein may be resistant to particulate matter (e.g., dust, lunar dust). For example, the thin trunk members 112 may have space between them that allows dust to fall away. Additionally, the space between trunk members 112 may reduce and/or avoid splay caused by particulate accumulation. For example, the large diameter engagement zone of the head portions 114 coupled with the reduced diameter trunk members 112 can be configured to prevent wire splay from dust entrapment at the protrusion base 108 of the respective protrusions 106 and/or, more generally, at the contact base 110. Beneficially, the open structure at the protrusion base 108 and/or, more generally, the contact base 110, minimizes and/or otherwise reduces risk (e.g., reduce reliability, damage, increased contact resistance) due to splayed wires from dust particles.

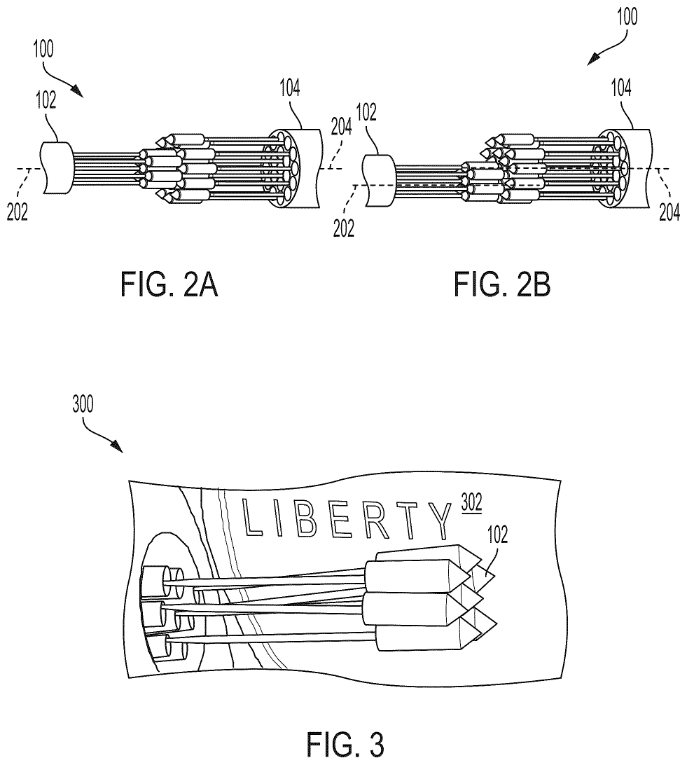

FIG. 2A shows the pair of mating contacts 102, 104 of FIG. 1A mated together with their respective axes 202, 204 aligned. In the shown example, the first contact 102 has a first primary central contact axis 202 aligned with a second primary central contact axis 204 of the second contact 104. In the shown example, the first contact 102 engages all of its seven protrusions 106 with a subset of at least seven of the protrusions 106 of the second contact 104.

FIG. 2B shows the pair of mating contacts 102, 104 of FIG. 1A mated together with their respective axes 202, 204 misaligned. In the shown example, the first contact 102 engages all of its seven protrusions 106 with a subset of at least seven of the protrusions 106 of the second contact 104 even when the axes 202, 204 are offset. For example, the contacts 102, 104 may be tolerant to axial misalignment as shown.

In the shown example, the first axis 202 may be misaligned and/or offset with respect to the second axis 204 by up to 0.020 inches without any increase in contact engagement force. For example, the contacts 102, 104 can engage even when their respective axes 202, 204 are offset, which may occur without an increase in contact engagement force. Alternatively, the contacts 102, 104 may be configured to enable the first axis 202 to be misaligned and/or offset with respect to the second axis 204 by up to a different distance (e.g., 0.025 inches, 0.030 inches, etc.). Beneficially, the “dart” and “target” configuration of the contacts 102, 104 has increased positional tolerance absorption with minimal and/or otherwise reduced impact on the mating force (e.g., the contact engagement force).

FIG. 3 shows a close-up photograph 300 of an example implementation of the first contact 102 of FIG. 1A. The first contact 102 is shown in FIG. 3 adjacent to a United States of America one-cent coin 302 (i.e., a penny) for scale.

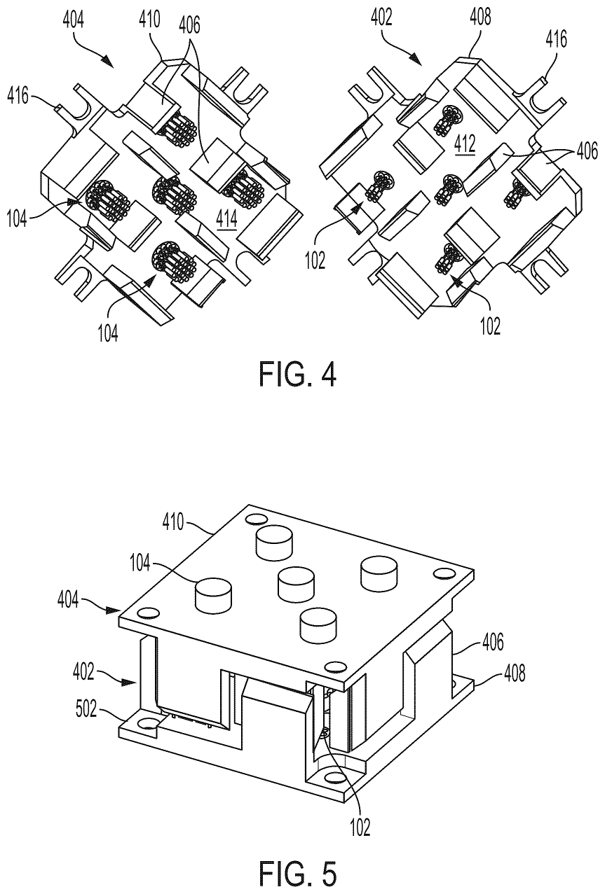

FIG. 4 shows an example of mating connectors 402, 404 including the pair of mating contacts 102, 104 of FIG. 1A. The mating connectors 402, 404 include a first connector 402 and a second connector 404. The connectors 402, 404 shown are 5-pole implementations. For example, the first connector 402 is shown to include five of the first contacts 102. In such an example, the second connector 404 is shown to include five of the second contacts 104 to mate with the first contacts 102. For example, the first contacts 102 may be disposed in the first connector 402 such that, when mated to the second connector 404, a subset of the second contacts 104 mate to the first contacts 102.

In the illustrated example of FIG. 4, the connectors 402, 404 include protective dielectric towers 406 (not all labeled to avoid obscuring the figure) which may prevent incidental damage to the contacts 102, 104. For example, the dielectric towers 406 are members (e.g., raised members, extending members) that extend from the bases of the connectors 402, 404 to a height such that they provide mechanical and electrical separation between contacts. In this example, the connectors 402, 404 do not include blind cavities, which beneficially avoids entrapment of particulate matter (e.g., dust, lunar dust).

In some embodiments, the connectors 402, 404 may include self-aligning features that allows a small misalignment when mating. Examples of self-aligning features include the dielectric towers 406, guide pins, and guide rails (e.g., dovetails). The spacing between the contacts 102, 104 and the dielectric towers 406 permit the connectors 402, 404 to mate when the connector axes are radially misaligned (as shown in FIG. 2B). In this example, the connectors 402, 404 permit radial misalignment up to 0.02 inches. Alternatively, the connectors 402, 404 may be configured such that they permit a different range of radial misalignment, such as a range of 0 to 0.01 inches, 0 to 0.03 inches, and so on.

The connectors 402, 404 may be blind-mateable without mechanical float bushings or spring mechanisms. For example, the connectors 402, 404 may be blind-mateable such that they may be mated to each other through a sliding or snapping action, without requiring additional tools (e.g., wrenches). In such an example, the connectors 402, 404 may be blind-mateable such that they may be secured to each other using a non-threaded interlock or no locking system at all.

Vertical mounting of the connectors 402, 404 at a 45 degree orientation, as shown in FIG. 4, permits loose particulate matter to migrate (or fall) out of the bottom of the connectors 402, 404 due to gravity. Alternatively, the connectors 402, 404 may be mounted at different angles.

The connectors 402, 404 include housings 408, 410. The housings 408, 410 have bases 412, 414 on which the contacts 102, 104 are mounted. The housings 408, 410 may be formed of any suitable material, such as a non-conductive material (e.g., dielectric material). An example of a non-conductive material is a polymer. The housings 408, 410 in the shown example may be mounted to respective structures by coupling fasteners through mounting ears 416. Examples of fasteners include bolts and screws (and/or corresponding nuts and washers).

Alternatively, the housings 408, 410 may be mounted to respective structures by coupling fasteners through mounting ears 502 shown in FIG. 5, which shows the mating of example implementations of the connectors 402, 404 of FIG. 4. The mounting ears 502 shown in FIG. 5 are configured to include through-holes through which a fastener may be inserted for securing the housings 408, 410 to respective structures.

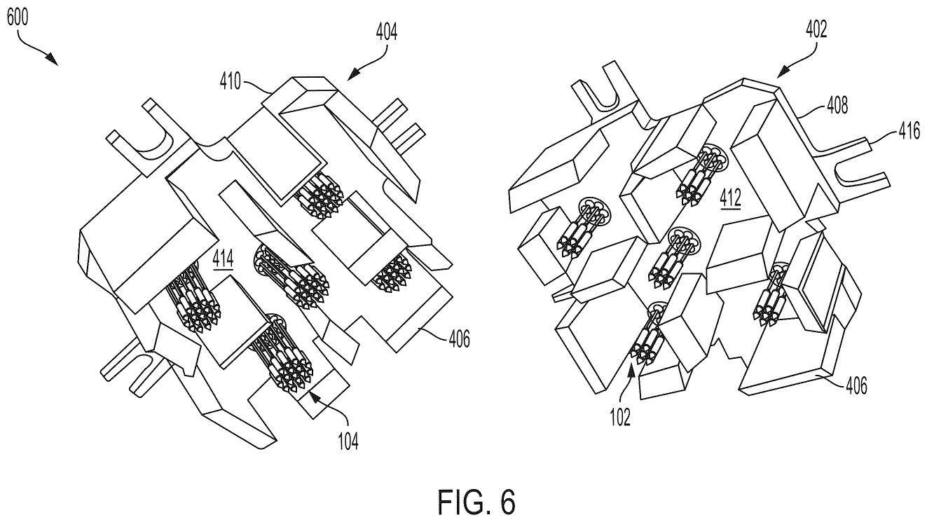

FIG. 6 shows a photograph 600 of a large scale mockup version of the mating connectors 402, 404 of FIG. 4.

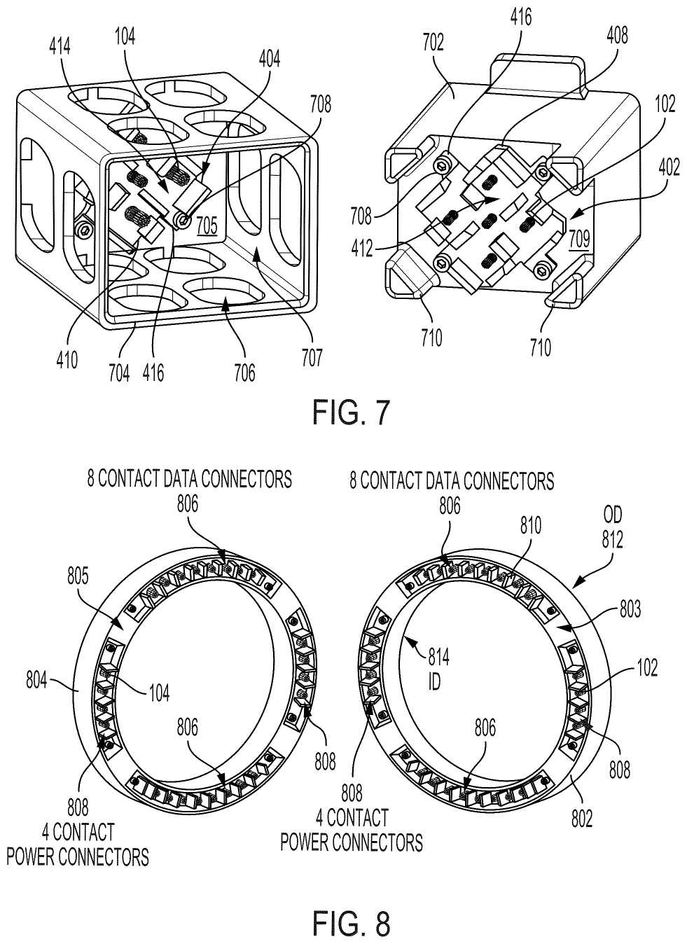

FIG. 7 shows example alignment structures 702, 704 including the connectors 402, 404 of FIG. 4. The alignment structures 702, 704 include an insertion alignment structure 702 and a receiving alignment structure 704. The receiving alignment structure 704 includes the second connector 404, which includes the second mating contact 104. The receiving alignment structure 704 includes a base 705 and four sides 707 that extend from the base 705. The base 705 shown is a rectangular base. The base 705 and the sides 707 form a rectangular housing. As shown, the rectangular housing is a rectangular box with an open end at the mating end to receive the insertion alignment structure 702, which includes the first connector 402. As shown, additional openings 706 may be formed in the sides 707 of the receiving alignment structure 704 to allow particulate matter to fall out. The insertion alignment structure 702 includes a base 709 (e.g., a rectangular base) that also has the shape of a rectangular box configured to be inserted through the opening of the mating end of the receiving alignment structure 704. However, this is an example and the alignment structures 702, 704 need not have a rectangular shape, and in other examples may have another shape, such as another polygonal shape, for example. For example, the base 705 and the sides 707 may be circular such that they establish a cylindrical housing. In such an example, the base 709 may be cylindrical such that it may be inserted into the cylindrical housing formed by the base 705 and the sides 707 of the receiving alignment structure 704.

The first connector 402 is affixed to the back of the insertion alignment structure 702 by using fasteners 708 and the mounting cars 416. The fasteners 708 are shown as bolts (e.g., threaded bolts), but other types of fasteners may be used such as screws. In some embodiments, the fasteners 708 are inserted through the bases 412, 414 and into respective standoff mounts (not shown) affixed to the back of the insertion alignment structure 702. The standoff mounts may be configured with threaded openings to receive the fasteners 708. Standoff mounts may be used to create separation between the base 412 of the first connector 402 and the back (e.g., the base) of the insertion alignment structure 702 to enable particulate matter to fall out.

The second connector 404 is coupled to the receiving alignment structure 704. In the shown example, the housing 410 of the second connector 404 is affixed to the back of the receiving alignment structure 704 by using the fasteners 708 and the mounting cars 416. In some embodiments, the fasteners 708 are inserted into respective standoff mounts (not shown) affixed to the back of the receiving alignment structure 704. Standoff mounts may be used to create separation between the base 414 of the second connector 404 and the back of the receiving alignment structure 704 to enable particulate matter to fall out.

In the illustrated example, the insertion alignment structure 702 is sized and shaped to fit into the receiving alignment structure 704 such that the contacts 102, 104 of the connectors 402, 404 are aligned and engage with one another when the insertion alignment structure 702 is inserted into the receiving alignment structure 704.

The insertion alignment structure 702 is shown in this example to include standoffs 710. Standoffs 710 are shown as triangular protrusions at the corners of the insertion receiving structure 702 that extend from the base of the insertion receiving structure 702. Alternatively, the standoffs 710 may be circular or have another polygonal shape, for example. Standoffs 710 may help prevent over-insertion and/or damage caused by excessive force on the contacts 102, 104. However, this is an example, and in other examples standoffs 710 may be positioned on the receiving alignment structure 704 instead of or in addition to being positioned on the insertion alignment structure 702. For example, the insertion alignment structure 702 may have a first set of standoffs and the receiving alignment structure 704 may have a second set of standoffs, which may be configured to receive the first set of standoffs to secure the insertion alignment structure 702 to the receiving alignment structure 704.

The connectors described herein may take on various shapes and configurations depending on the application.

In some applications, one or more connectors may be disposed on a ring-shaped interface. For example, a first ring-shaped interface may have one or more first connectors that include the first contacts 102, and a second ring-shaped interface configured to mate with the first ring-shaped interface may have the second contacts 104.

One example of an application in which a ring-shaped interface may be used is in an arm for an extraterrestrial rover (e.g., a lunar rover). Such an interface may enable mechanical and electrical connections between the arm and the body of the rover. The contacts described herein, such as the contacts 102, 104, may be used in such an application. Another example of an application in which a ring-shaped interface may be used is an arm for a robot such as a Cartesian robot (also known as a linear robot or a gantry robot). Beneficially, the ability of the contacts 102, 104 to engage when misaligned permits them to be rigidly misaligned and permits them to be rigidly mounted to mechanical coupling systems without stressing and/or degrading the electrical connector and corresponding contacts.

FIG. 8 shows an example in which a first ring-shaped interface 802 includes connectors 806, 808 including contacts 102 and a second ring-shaped interface 804 includes contacts 104 configured to mate with contacts 104 of the first ring-shaped interface 802. The ring-shaped interfaces 802, 804 include a respective base 803, 805. The bases 803, 805 are cylindrical. The bases 803, 805 include and expose the contacts 102, 104 for mating. For example, the circular base of the first ring-shaped interface 802 is configured to mate to the circular base of the second ring-shaped interface 804 such that the contacts 102 mate to the contacts 104. The connectors 806, 808 may include dielectric towers 810 separating one or more contacts, which may aid with alignment and/or stand-off.

In the shown example, the connectors 806, 808 include data connectors 806 and power connectors 808. For example, the data connectors 806 may be used to transfer communication data in accordance with a protocol such as 10Base-T, 100Base-T Ethernet, 100Base-TX Ethernet, 100Base-T4 Ethernet, and 1000Base-T Ethernet, USB, and SPI. The data connectors 806 are shown to have 8 contacts but may have a different number of contacts in other examples. The power connectors 808 may be used to transfer power and are shown to have 4 contacts, but a different number of contacts may be used. The particular numbers and use (e.g., power/data) for the contacts is by way of example and not limitation.

The ring-shaped interfaces 802, 804 are depicted as having an example outer diameter (OD) 812 and an example inner diameter (ID) 814. In some embodiments, the outer diameter 812 may be the same as the inner diameter 814. For example, the outer diameter 812 and the inner diameter may both be 100 millimeters (mm), 125 mm, 150 mm, etc. In some embodiments, the outer diameter 812 may be different than the inner diameter 814. For example, the outer diameter 812 may be 125 mm and the inner diameter may be 100 mm. The above-provided diameters are merely examples and different diameters may be used for the outer diameter 812 and/or the inner diameter 814.

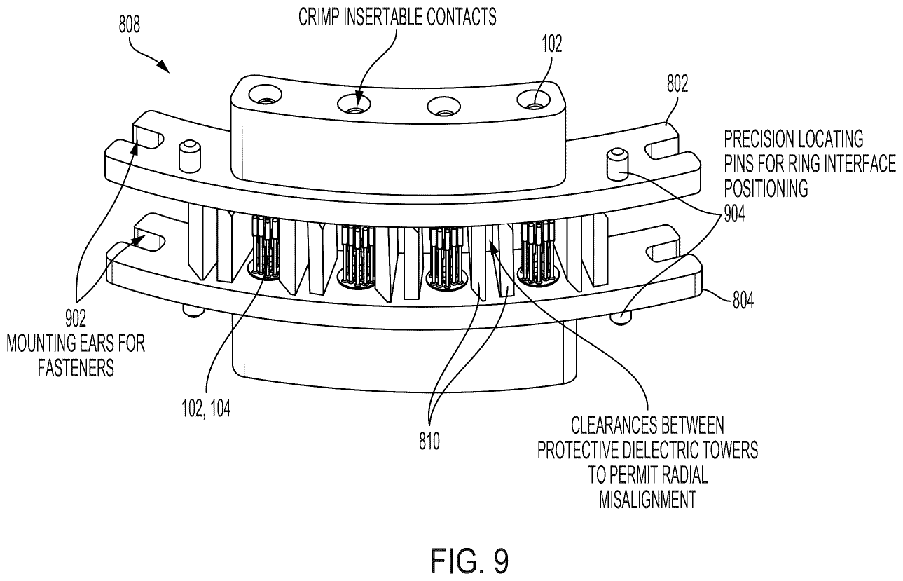

FIG. 9 shows an enlarged view of the pair of mating contacts 102, 104 of the ring-shaped interfaces 802, 804 fully engaged with each other. Specifically, FIG. 9 shows greater detail of one example of the four contact power connectors 808 of FIG. 8 fully engaged with one another. The particular types of mounting cars 902, fasteners, type of insertion (e.g., crimp-insertable) for the contacts, locating pins 904 and alignment tolerances shown in FIG. 9 are shown by way of example and not limitation. For example, mounting cars 902 for the respective ring-shaped interfaces 802, 804 may be configured to receive respective fasteners. Examples of fasteners include bolts and screws. By way of example, the mounting ears 902 may be configured to receive an M2 screw or a #1 screw. In another example, the contacts 102, 104 may be crimp-insertable contacts. In yet another example, the clearances between the protective dielectric towers 810 may permit radial misalignment up to a specified tolerance. For example, the clearances may permit radial misalignments up to 0.25 mm, 0.5 mm, 0.75 mm, and so on. Further shown are the locating pins 904, which may be precision locating pins for ring interface positioning and/or alignment.

Beneficially, the connectors described herein may be rigidly mounted to the two structures that are to be connected, and do not require a system of springs or bushings to tolerate misalignment, which may have difficulty in an environment with a large amount of particulate matter.

Examples of applications of the connectors described herein include use as an interface between a battery and a robot, or a robotic arm to a tool or end effector. For example, the first ring-shaped interface 802 may be mounted to a tool or end effector and the second ring-shaped interface 804 may be mounted to a robot. However, these are examples, and the connectors described herein are not limited to particular applications.

In one example application, to facilitate continuous robotic mining, it may be desired to robotically replace depleted batteries in a mining area, then charge the batteries remotely from the mining robots. In such an application, the receiving alignment structure 704 of FIG. 7 may be mounted to the battery receiving rack of the robot, and the insertion alignment structure 702 of FIG. 7 may be mounted to the interchangeable battery.

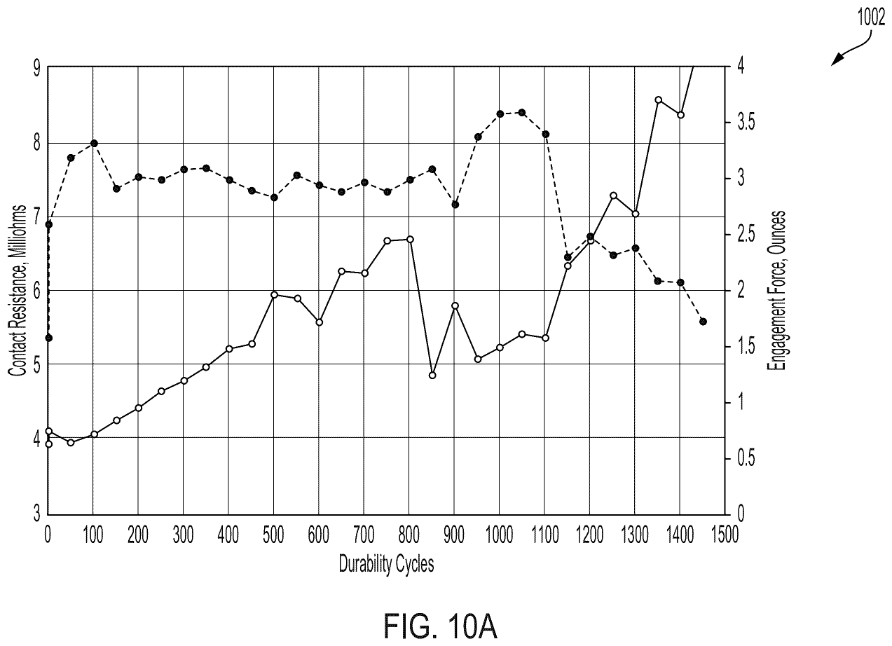

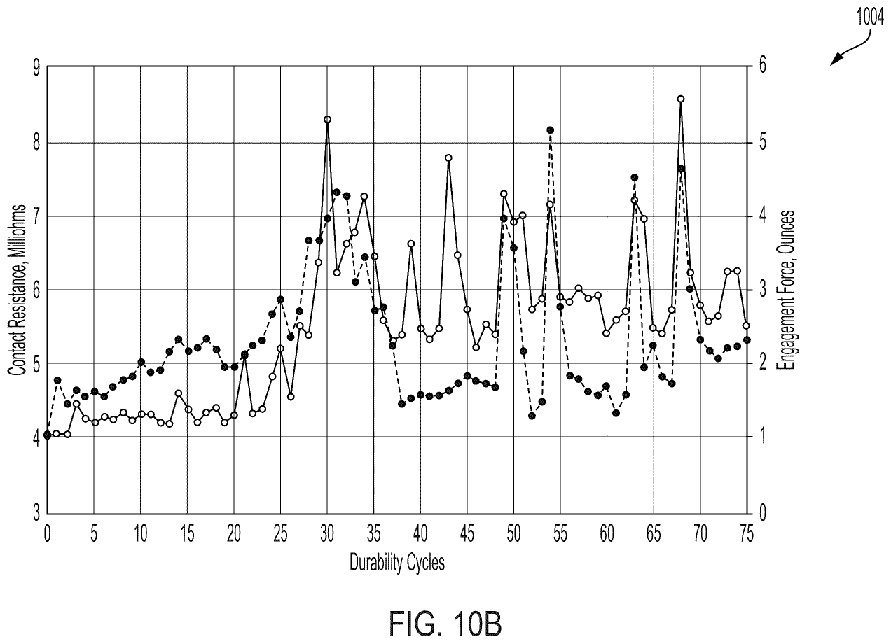

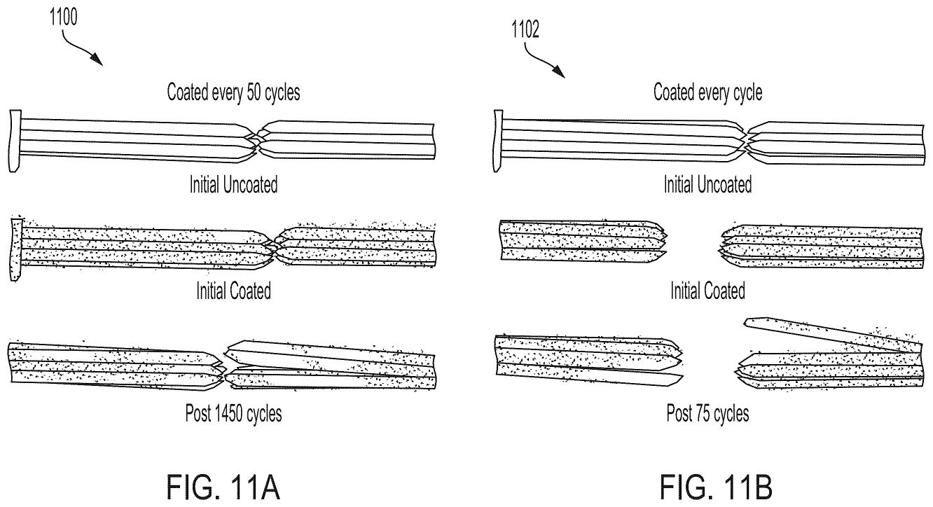

FIGS. 10A and 10B show graphs 1002, 1004 representing example contact resistance data associated with another example implementation of a pair of mating contacts shown in the close up photographs of FIGS. 11A and 11B over a plurality of durability cycles. The example implementation of the pair of mating contacts in FIGS. 11A and 11B is shown with trunk members of the mating contacts having the same thickness as the head portions. For example, the pair of mating contacts shown in FIGS. 11A and 11B may be brush contacts. A durability cycle may refer to a cycle of mating and separating a pair of mating contacts. For example, a durability cycle may refer to a cycle of mating and separating the pair of mating contacts 102, 104 of FIG. 1A or the pair of mating contacts shown in FIGS. 11A and 11B.

Returning to FIGS. 10A and 10B, the respective graphs 1002, 1004 have an x-axis representing a number of durability cycles, a first y-axis representing contact resistance in milliohms, and a second y-axis representing engagement force in ounces. FIG. 11A shows close-up photographs 1100 that correspond to the data represented by graph 1002. In FIG. 10A, graph 1002 represents the contact resistance and engagement force of the brush contacts shown in FIGS. 11A and 11B when coated with a lunar regolith simulant such as Lunar Mare Simulant (LMS-1) at every 50th durability cycle.

A lunar regolith simulant is a terrestrial material synthesized in order to approximate the chemical, mechanical, and/or engineering properties of, and the mineralogy and particle size distributions of, lunar regolith (e.g., lunar dust). For example, LMS-1 may be applied directly to the brush contacts of FIGS. 11A-11B to simulate a lunar environment. As shown in graph 1002, the contact resistance increases and the engagement force decreases over time and generally with respect to a number of performed durability cycles. For example, dips in contact resistance over time may indicate that LMS-1 falls out from the brush contacts of FIGS. 11A-11B due to the trunk members having space between them that allows dust, or in this case LMS-1, to fall away.

In FIG. 10B, graph 1004 represents the contact resistance and engagement force of the brush contacts of FIGS. 11A-11B when coated with a lunar regolith simulant such as LMS-1 between every durability cycle. FIG. 11B shows close-up photographs 1102 that correspond to the data represented by graph 1004. For example, LMS-1 may be applied directly to the brush contacts of FIGS. 11A-11B between every durability cycle to simulate a lunar environment. As shown in graph 1004, the contact resistance increases and the engagement force increases over time and generally with respect to a number of performed durability cycles. For example, dips in contact resistance and/or engagement force over time may indicate that LMS-1 falls out from the brush contacts of FIGS. 11A-11B due to the trunk members having space between them that allows dust, or in this case LMS-1, to fall away.

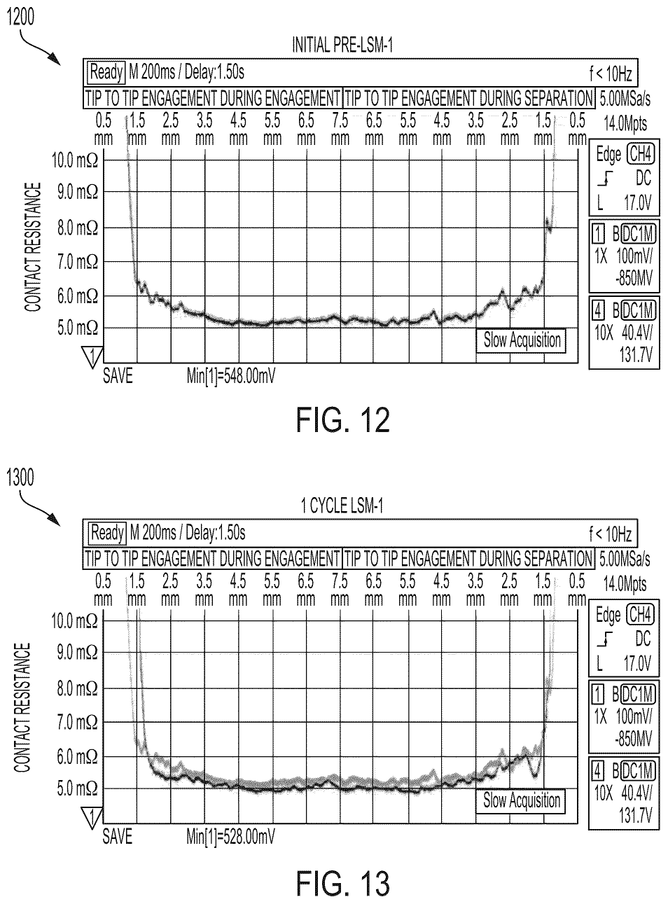

FIG. 12 shows a graph 1200 representing example contact resistance data for an example implementation of a pair of mating contacts. For example, the graph 1200 may represent contact resistance data for a scaled version (e.g., an enlarged version) of the pair of mating contacts 102, 104. For example, the graph 1200 may be generated using enlarged versions of the 7-wire dart and the 19-wire target pair of mating contacts 102, 104 shown in FIG. 1A. Alternatively, the graph 1200 may represent contact resistance data for the pair of mating contacts 102, 104 of FIG. 1A. In such an example, the graph 1200 may represent contact resistance data for a 7-wire dart and a 19-wire target pair of mating contacts during a durability cycle.

The enlarged versions may be at least 1.5 times larger, twice larger, thrice larger, etc., than the production size of the mating contacts 102, 104. For example, the enlarged versions may be at least twice the production size of the mating contacts 102, 104. Mating contacts that are enlarged versions of the mating contacts 102, 104 of FIG. 1A may be referred to as “power contacts” and the mating contacts 102, 104 may be referred to as “signal contacts”.

In the illustrated example of FIG. 12, the graph 1200 may represent contact resistance data for a pair of mating power contacts (e.g., an enlarged version of the mating contacts 102, 104 of FIG. 1A) during engagement and separation for a single durability cycle without application of a lunar regolith simulant such as LMS-1 to the pair of mating power contacts. The graph 1200 has an x-axis representing time and a y-axis representing contact resistance in milliohms. The graph 1200 includes contact resistance data corresponding to tip-to-tip engagement during engagement of the pair of mating power contacts and tip-to-tip engagement during separation thereof. As shown, the contact resistance spikes during initial engagement contact and spikes again upon final separation.

FIG. 13 shows a graph 1300 representing example contact resistance data for a pair of mating power contacts during engagement and separation for a single durability cycle after being coated with a lunar regolith simulant such as LSM-1. For example, the graph 1300 may represent contact resistance data for a 7-wire dart and a 19-wire target pair of mating power contacts during a single durability cycle. Alternatively, the graph 1300 may represent contact resistance data for a pair of mating signal contacts, such as the pair of mating contacts 102, 104 of FIG. 1A.

The graph 1300 of FIG. 13 has an x-axis representing time and a y-axis representing contact resistance in milliohms. The graph 1300 includes contact resistance data corresponding to tip-to-tip engagement during engagement of the pair of mating power contacts (or pair of mating signal contacts) and tip-to-tip engagement during separation. As shown, the contact resistance spikes during initial engagement contact and spikes again upon final separation. Beneficially, the contact resistance is relatively similar to the graph 1200, which is generated without coating the pair of mating power contacts (or pair of mating signal contacts) with LSM-1 indicating that at least portion(s) of the LSM-1 fell away during contact engagement/disengagement in the durability cycle corresponding to graph 1300.

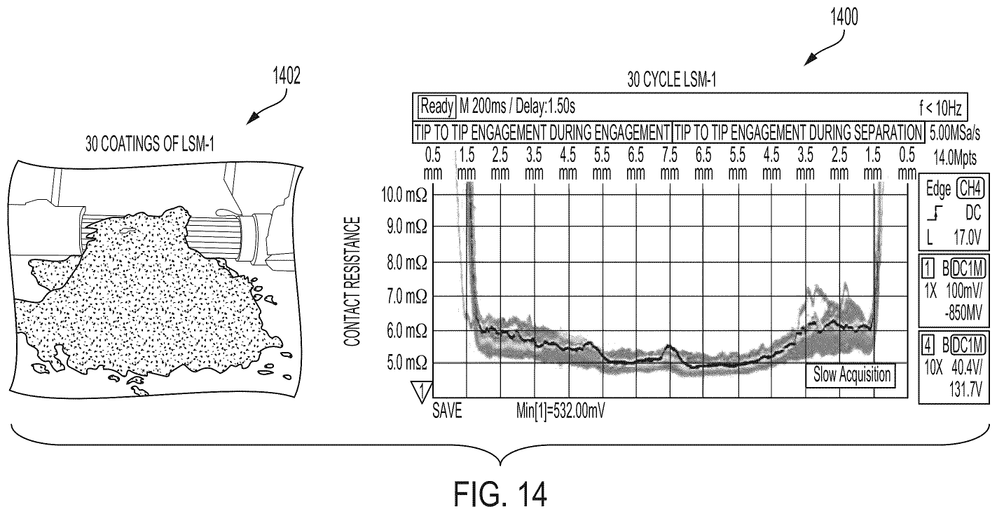

FIG. 14 shows a graph 1400 representing example contact resistance data for a pair of mating power contacts during engagement and separation after a first plurality of coatings of lunar regolith simulant such as LSM-1 have been completed. For example, the graph 1400 may represent contact resistance data for a 7-wire dart and a 19-wire target pair of mating power contacts during a first plurality of coatings. Alternatively, the graph 1400 may represent contact resistance data for a pair of mating signal contacts, such as the pair of mating contacts 102, 104 of FIG. 1A.

In the illustrated example, the first plurality of coatings corresponds to 30 durability cycles. For example, the graph 1400 may represent the contact resistance for the pair of mating power contacts during the 30th durability cycle. The graph 1400 has an x-axis representing time and a y-axis representing contact resistance in milliohms. The graph 1400 includes contact resistance data corresponding to tip-to-tip engagement during engagement of the pair of mating power contacts (or pair of mating signal contacts) and tip-to-tip engagement during separation thereof during the 30th durability cycle. As shown, the contact resistance spikes during initial engagement contact and spikes again upon final separation. Beneficially, contact resistance is relatively low (approximately 5.5 milliohms) when fully engaged, which indicates that coating of the pair of mating power contacts with LSM-1 has reduced impact. Also shown is a photograph 1402 of the pair of mating power contacts buried in LSM-1 after 30 durability cycles.

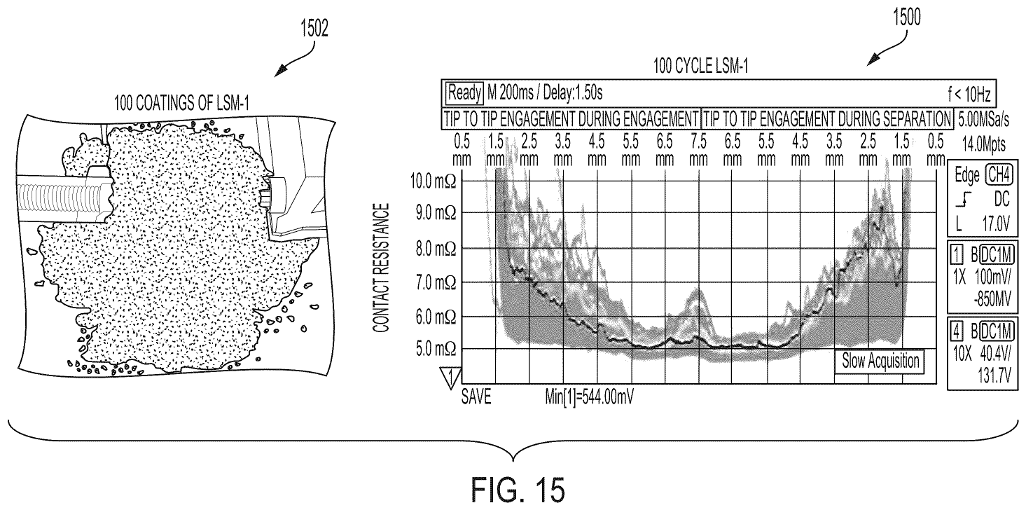

FIG. 15 shows a graph 1500 representing example contact resistance data for a pair of mating power contacts during engagement and separation after a second plurality of coatings of lunar regolith simulant such as LSM-1 have been completed. For example, the graph 1500 may represent contact resistance data for a 7-wire dart and a 19-wire target pair of mating power contacts during a second plurality of coatings. Alternatively, the graph 1500 may represent contact resistance data for a pair of mating signal contacts, such as the pair of mating contacts 102, 104 of FIG. 1A.

In the illustrated example, the second plurality of coatings corresponds to 100 durability cycles. For example, the graph 1500 may represent the contact resistance for the pair of mating power contacts during the 100th durability cycle. The graph 1500 has an x-axis representing time and a y-axis representing contact resistance in milliohms. The graph 1500 includes contact resistance data corresponding to tip-to-tip engagement during engagement of the pair of mating power contacts (or pair of mating signal contacts) and tip-to-tip engagement during separation thereof during the 100th durability cycle. As shown, the contact resistance spikes during initial engagement contact and spikes again upon final separation. Beneficially, contact resistance is relatively low (approximately 6.8 milliohms) when fully engaged, which indicates that successive coatings of the pair of mating power contacts with LSM-1 has reduced impact. Also shown is a photograph 1502 of the pair of mating power contacts buried in LSM-1 after 100 durability cycles.

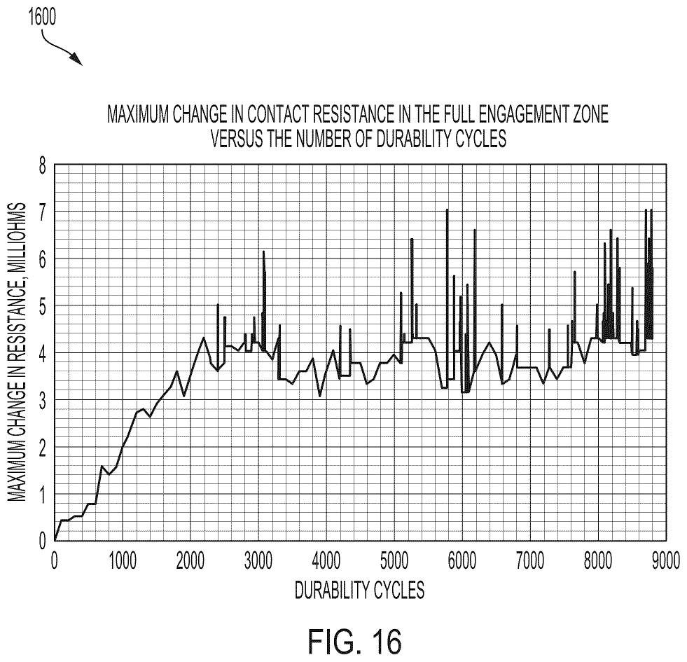

FIG. 16 shows a graph 1600 representing example maximum changes in contact resistance data for a pair of mating power contacts during engagement and separation for a plurality of durability cycles. For example, the graph 1600 may represent maximum changes in contact resistance data for a 7-wire dart and a 19-wire target pair of mating power contacts during a plurality of durability cycles. Alternatively, the graph 1600 may represent maximum changes in contact resistance data for a pair of mating signal contacts, such as the pair of mating contacts 102, 104 of FIG. 1A. As shown, the spikes in the graph 1600 represent single events that occurred on one cycle then reset to lower values on the subsequent durability cycle.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

The terms “substantially,” “approximately,” “about” and the like refer to a parameter being within 10%, optionally less than 5% of its stated value.

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc., described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

1. An electrical connector, comprising:
at least one contact having a plurality of protrusions, individual protrusions of the plurality of protrusions having:
a trunk member; and
a head portion extending from the trunk member, wherein a thickness of the trunk member is less than a thickness of the head portion.

2. The electrical connector of claim 1, wherein the head portion is tapered at a mating end of the at least one contact.

3. The electrical connector of claim 1, wherein the head portion has a first end and a second end, the second end opposite the first end, and the head portion is tapered at each of the first end and the second end.

4. The electrical connector of claim 1, wherein the trunk member comprises a wire.

5. The electrical connector of claim 1, wherein the thickness of the head portion is at least twice the thickness of the trunk member.

6. The electrical connector of claim 1, wherein the plurality of protrusions extends in a same direction.

7. The electrical connector of claim 1, wherein at least one pair of adjacent head portions of the plurality of protrusions is spaced apart by less than a width of either of the pair of adjacent head portions.

8. The electrical connector of claim 1, wherein a direction of the thickness of the trunk member and the head portion is perpendicular to an extension direction, the extension direction corresponding to a longest dimension of the individual protrusions.

9. The electrical connector of claim 1, further comprising a housing configured to align the at least one contact with a second at least one contact to be mated to the at least one contact.

10. A pair of mating electrical connectors, comprising:
a first connector having a first at least one contact having a first plurality of protrusions, individual first protrusions of the first plurality of protrusions having:
a first trunk member; and
a first head portion, wherein a thickness of the first trunk member is less than a thickness of the first head portion; and
a second connector having a second at least one contact having a second plurality of protrusions, individual second protrusions of the second plurality of protrusions having:
a second trunk member; and
a second head portion, wherein a thickness of the second trunk member is less than a thickness of the second head portion.

11. The pair of mating electrical connectors of claim 10, wherein a quantity of the first plurality of protrusions is greater than a quantity of the second plurality of protrusions.

12. The pair of mating electrical connectors of claim 11, wherein the quantity of the first plurality of protrusions is at least 7 and the quantity of the second plurality of protrusions is at least 7.

13. The pair of mating electrical connectors of claim 10, wherein a quantity of the first plurality of protrusions is the same as a quantity of the second plurality of protrusions.

14. The pair of mating electrical connectors of claim 10, wherein the first connector has a first axis, the second connector has a second axis, and the first connector is configured to establish an electrical connection with the second connector when the first axis is misaligned with the second axis.

15. An electrical connector, comprising:
a base; and
at least one contact coupled to the base, the at least one contact having a plurality of protrusions, individual protrusions of the plurality of protrusions having:
a trunk member; and
a head portion extending from the trunk member, wherein a thickness of the trunk member is less than a thickness of the head portion.

16. The electrical connector of claim 15, wherein the at least one contact is a first at least one contact, and further comprising:
a second at least one contact; and
at least one dielectric member coupled to the base in a space between the first at least one contact and the second at least one contact.

17. The electrical connector of claim 15, wherein the at least one contact comprises at least 4 contacts.

18. The electrical connector of claim 15, wherein the base is rectangular.

19. The electrical connector of claim 15, wherein the base is circular.

20. The electrical connector of claim 15, further comprising an alignment structure comprising the base, the alignment structure further comprising at least one side, and the at least one side comprises at least one opening.
